(19) United States
(12) Patent Application Publication
(10) Pub. No.: US 2013/0185717 A1
(43) Pub. Date: Jul. 18, 2013

(54) METHOD AND SYSTEM FOR MANAGING POWER CONSUMPTION DUE TO VIRTUAL MACHINES ON HOST SERVERS

(71) Applicant: Sitaraman Suthamali LAKSHMINARAYANAN, Dunwoody, GA (US)

(72) Inventor: Sitaraman Suthamali LAKSHMINARAYANAN, Dunwoody, GA (US)

(21) Appl. No.: 13/350,080

(22) Filed: Jan. 13, 2012

(51) Int. Cl. G06F 9/455

(52) U.S. Cl. 718/1

(57) ABSTRACT

A method to manage virtual machines operating on host servers in a data center including: receiving demand event information at the data center; a demand request (DR) inference engine responds to the demand event or a request by a demand request (DR) agent software module operating on one of the host severs, wherein the response by the DR inference engine is to identify virtual machines which may be shutdown or idled as a response to the demand event; in response to the demand event information and information provided by the DR inference engine, the DR agent generates an instruction to a selected virtual machine on the host machine associated with the DR agent, and in response to the instruction, the virtual machine shuts down or becomes idle.

### BACKGROUND OF THE INVENTION

This invention relates to power management in a computer data center and particularly to management of computer servers hosting virtual computing machines in the data center.

A computer data center is typically a facility housing and supporting many computer devices. These devices may include computer servers mounted on racks, and Ethernet switches or routers that allow the servers to communicate with each other and to external computer systems. A computer data center may also include electronic storage devices, e.g., disk drives, electrical power systems, back-up power supply battery systems, cooling systems for the computers and other electronic systems and computer control systems.

The electrical power consumed by a computer data center may be substantially greater than a conventional facility, such as a warehouse or office building. A computer data center may require hundreds of watts of energy per square foot as compared to a commercial warehouse which may require 20 to 10 watts (W) per square foot. The total power consumption by a small computer data center may by, for example, 1 mega watt (MW) and by a large center may be 10 to 30 MW. The computer servers in the data center may consume about a third of the total power consumed by a computer data center.

The power consumed by a data center is normally supplied by an electrical power utility via a power grid. Power supplied to the data center is subject to interruption due to weather and other events. When power from the utility is interrupted, the data center may switch to a backup power source, such as generators and batteries at the site of the data center. These backup power sources may not be sufficient to supply all of the power regularly used by the data center for an extended period.

When faced with a power interruption, the data center conventionally reduces power consumption by manually shutting down or idling selected host severs in the data center. The conventional approach to shutting down or idling host servers in response to a power interruption is too dependent on manual intervention. There is a long felt need for a method and system to reduce power consumption in a data center in respond to a power interruption or other power demand event.

### BRIEF DESCRIPTION OF THE INVENTION

A method to manage virtual machines operating on host servers in a data center has been conceived which includes: receiving demand event information at the data center; a demand request (DR) inference engine responds to the demand event or a request by a demand request (DR) agent software module operating on one of the host severs, wherein the response by the DR inference engine is to identify virtual machines which may be shutdown or idled as a response to the demand event; in response to the demand event information and information provided by the DR inference engine, the DR agent generates an instruction to a selected virtual machine on the host machine associated with the DR agent, and in response to the instruction, the virtual machine shuts down or becomes idle. The demand event may relate to a power outage and the information is supplied by a power utility. The DR agent may send a subsequent instruction to the virtual machine in response to additional demand event information, wherein the virtual machine resumes operation in response to the subsequent instruction.

The DR agent or DR inference engine may select the virtual machines to be shutdown or idled based on whether the virtual machines are designated as being available to being shut down or idled in response to a demand event. The number and selection of virtual machines to be shutdown or idled may be to achieve a desired power reduction by the data center.

A system to manage virtual machines operating on host servers in a data center has been conceived comprising: the virtual machines are each hosted on a respective one of the host severs; a demand agent on each of the host servers having a virtual machine, wherein the demand agent generates instructions to a selected at least one of the virtual machines on the host server having the demand agent and the instructions include commands to shut-down or idle and the instructions are generated using information regarding virtual machines which may be shut down or idled and a number of virtual machines to be shut down or idled, and a demand request (DR) inference engine hosted on a host server in a control system of the data center, wherein the DR inference engine responds requests by the demand request (DR) agents for information regarding virtual machines which may be shutdown or idled in response to the demand event and a number of virtual machines to be shut down or idled.

### BRIEF DESCRIPTION OF THE DRAWINGS

FIG. 1 is a schematic diagram of a computer data center having computer servers.

FIG. 2 is a process flow for adjusting the virtual machine load level on a computer server using demand response agents.

FIGS. 3 to 6 are a flow chart of an exemplary method for a computer data center to respond to a demand event.

### DETAILED DESCRIPTION OF THE INVENTION

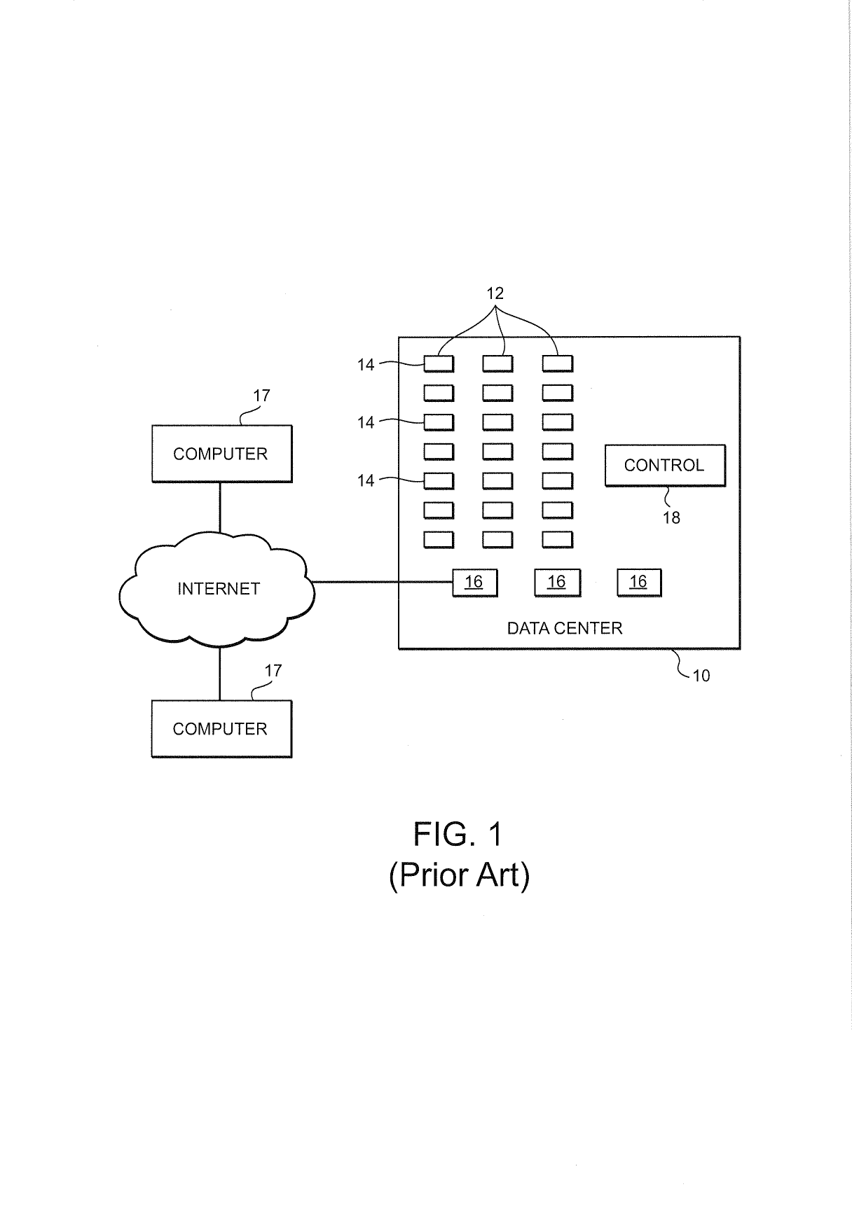

FIG. 1 shows schematically a computer data center 10 having many, e.g., hundreds or thousands, of servers 12, that may be arranged in rows of stacks 14. Ethernet switches or routers 16 provide data pathways that allow the servers to exchange data and commands and to communicate with external computer systems 17 such as via the internet. A control system 18 monitors and controls the components in the data center, such as by setting and balancing the virtual machines on each of the servers.

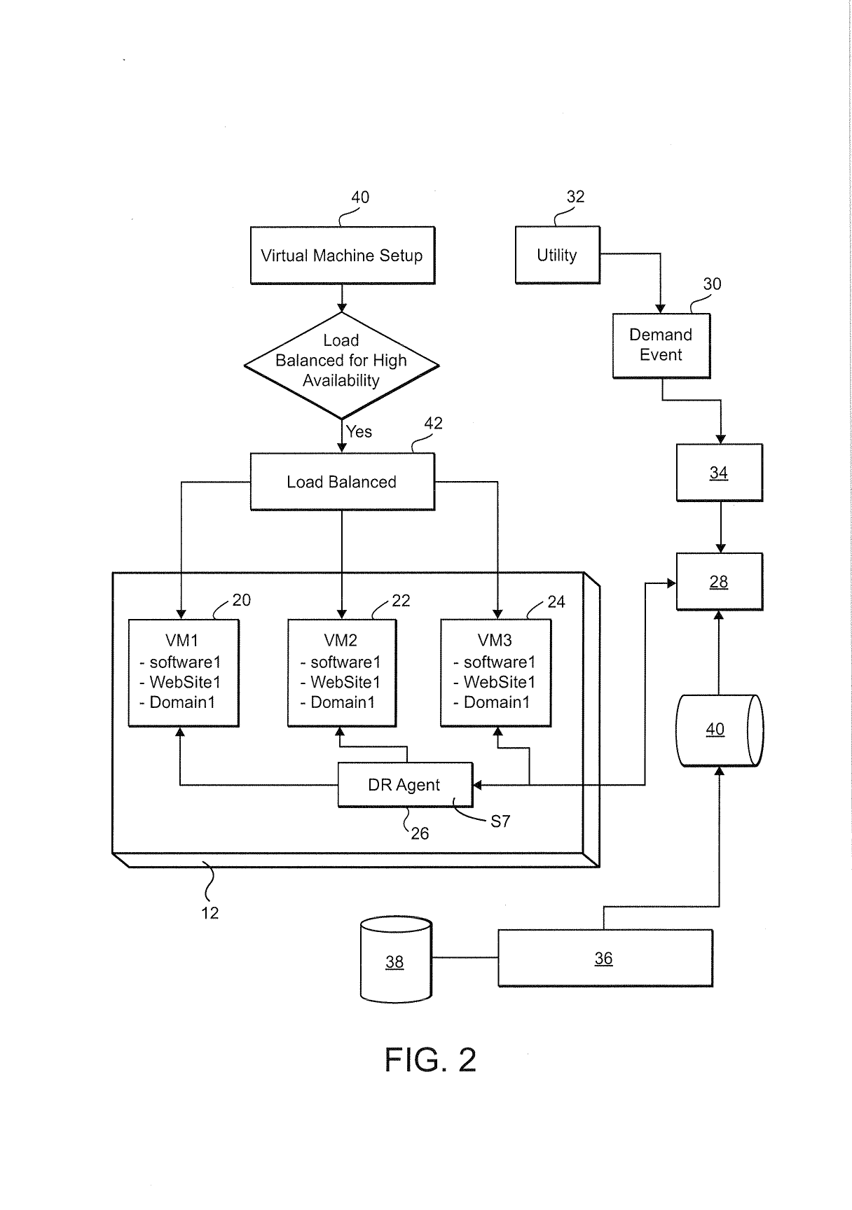

FIG. 2 illustrates several virtual machines 20, 22, 23 each operating on one of the servers 12 in the computer data center. FIG. 2 is representative of each of the host servers in the data center.

A virtual machine may be an isolated software based system that includes an operating system 24 and one or more software applications 26, 28 that run on the operating system and within the virtual machine. The term virtual implies that the machine is software based and does not include the traditional physical components of a computing machine, such as a central processing unit (CPU), electronic memory and a computer-to-computer communication device. In many respects, a virtual machine may have virtual components that mirror the components of a physical computer. For example, a virtual machine may include a virtual CPU, an electronic memory such as random access memory (RAM), and a computer-to-computer interface device such as a network interface card (NIC). The virtual machine may interact with other computers in the same manner as if the virtual machine where a physical computer.

Virtual machines consume electrical power. A virtual machine draws power by requiring resources from the physical components of the server, such as the processors, memory and data communication components. The power consumed by a virtual is the portion of the power consumed by the host server which is attributable to resources of the host server allocated to the virtual machine. The power consumption of a host server may be reduced by idling or shutting down a virtual machine that is loaded on the host server.

FIG. 2 illustrates a process flow for adjusting the virtual machine load level on a computer server 12 using demand response agents. Several mirrored virtual machines 20, 22, 24 are hosted on the server 12. In this example, each virtual machine (VM1, VM2 and VM3) has software to perform a function for a website (WebSite1) for a particular internet domain (Domain1).

The virtual machines may each perform different functions. For example, several virtual machines may be used to provide the functions needed to support an internet website (WebSite1). One virtual machine 20 may function as the website server, a second virtual machine may provide middle tier website services, and the third virtual machine 24 may host the databases associated with the web application. The website sever 22 may provide a user interface allowing a customer or other user of the website to interact with the web application. The second virtual machine 22 providing middle tier, e.g., logic tier, functions may process user commands received via the user interface and control data moving between the website server and the database server.

Further, the virtual machines may be mirrored such that two or more virtual machines perform identical functions. Mirrored virtual machines provide redundancy and additional capacity for websites and other computer services. The mirrored virtual machines may be distributed on multiple host servers. During high customer demand on a website, several mirrored virtual machines may function as the website server for the website domain. During lower demand, a reduced number of mirrored servers may function as the website server for the domain. In addition, the number of mirrored virtual machines may selected to provide a desired level of reliability for a computer service.

As an example, a web application may require between three and nine mirrored virtual machine for each tier of website functionality, e.g., website server, middle tier website services and database host. In this example, a web application may require as many as twenty-seven (27) virtual machines and as few as nine (9) virtual machines to provide nine mirrored virtual machines for each of the three tiers of web functions.

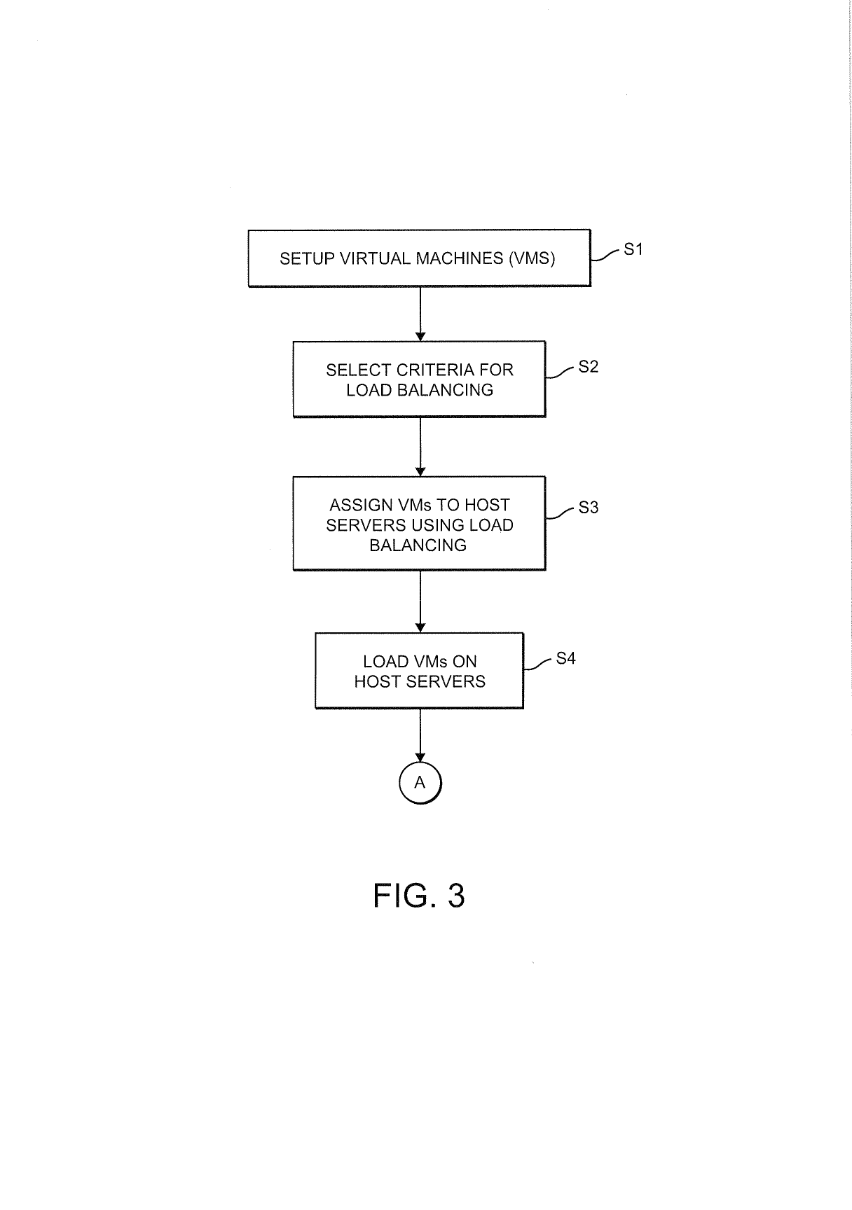

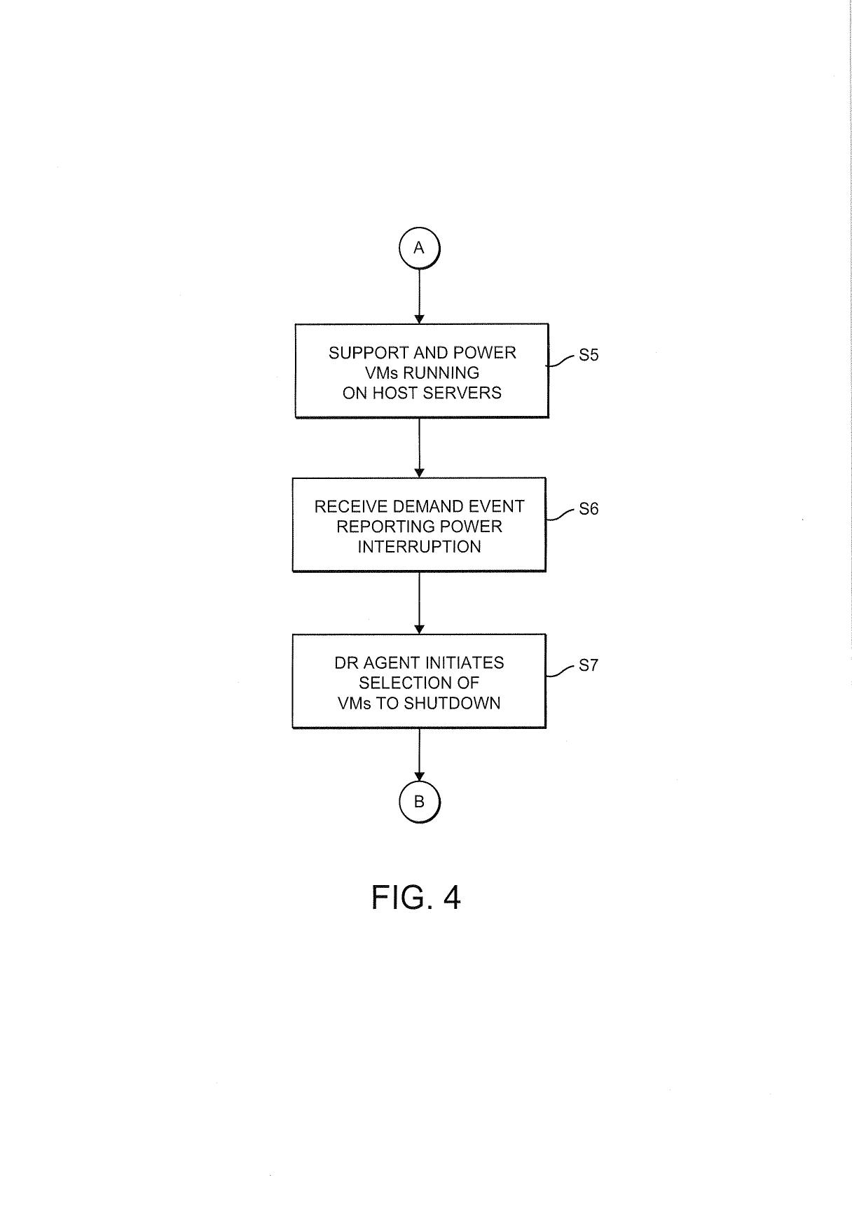

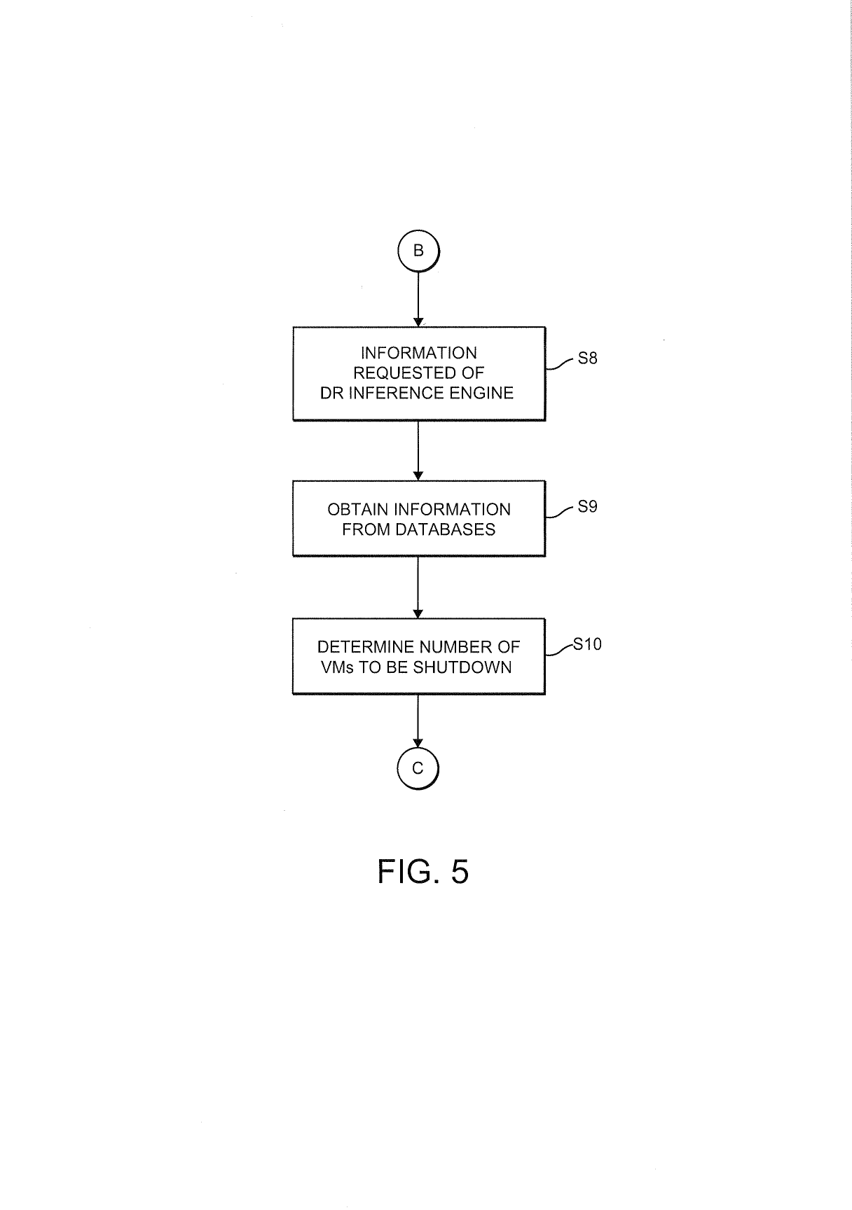

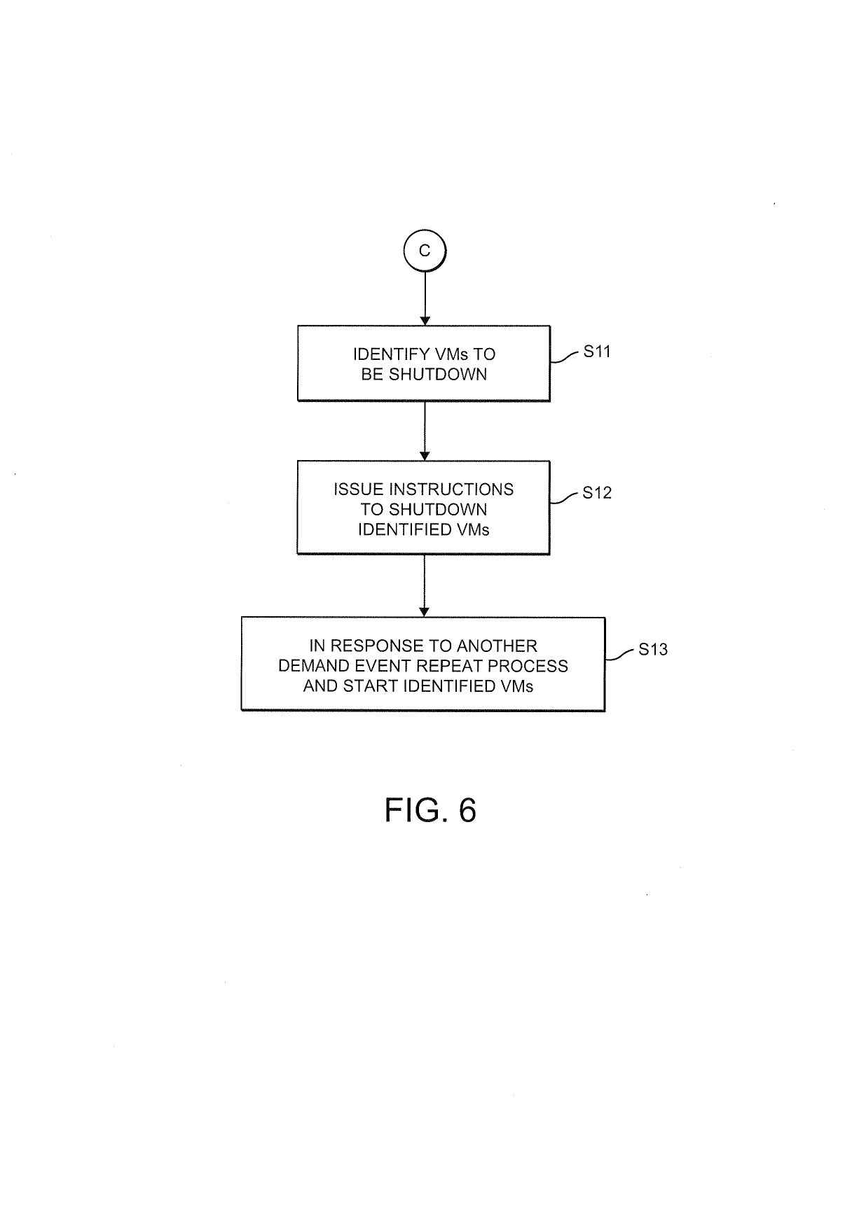

FIGS. 3 to 6 are a process flow chart of an exemplary method for setting up virtual machines on host servers and responding to demand events, e.g., a power interruption, by shutting down or idling selected virtual machines.

During the setup (step S1) of a virtual machine, the software and software settings for each of the virtual machines (VM1-20, (VM2-22), (VM3-24) are determined and configured. The virtual machine setup (S1 and 40) may be performed in a conventional manner.

A conventional load balancing software program 42 may be used in steps S2 and S3 to select a host server 12 for each of the virtual machines. The load balancing may be performed to achieve a desired result, such as a certain level of availability of the function provided by the mirrored virtual machine. In step S2, the desired result is selected for the load balancing process.

The load balancing step S3 may include selecting a host server 12 for each virtual machine and determining a priority of virtual machines on each server. The physical server 12 uses the priority to schedule access by each of the virtual machines to the physical processors and other physical components of the servers. A high priority ensures that a virtual machine will have access to physical components of a server when needed by the virtual machine. A low priority may result in a virtual machine waiting for physical components while the server components are being used by virtual machines having a higher priority.

In step S4, the virtual machines 20, 22, 24 are loaded on each of the selected physical servers 12 and each assigned a priority depending on the load balancing process. In step S5, the server 12 supports and provides resources for each of the virtual machines 20, 22, 24 running on the server. The virtual machines on the sever 12 may included mirrored copies to increase the capacity and availability of a website to perform a website function. Further, the mirrored virtual machines may be spread over different physical servers. The virtual machines on the server 12 may include virtual machines performing different functions to support a website.

Each host server 12 may also include a demand response (DR) agent 26 which can idle or close any of the virtual machines operating on the host sever. The DR agent is a software program, e.g., software module, which generates instructions to the virtual machines which cause the virtual machine receiving the instruction to, for example, start, idle or shutdown. The DR agent determines which of the virtual machines to idle or shutdown based on a demand response event 30 and demand response data and other information that may be received from a demand response (DR) inference engine 28, which is a software module that may be stored on and executed by a computer server in the control system 18 (FIG. 1) of the data center 10.

The demand events 30 are information transmitted to the DR agents that indicate whether a power failure or power reduction has occurred the data center 10. The demand events may also include information from a power utility 32 regarding the cost of power, e.g., kilowatts per hour, power reductions, e.g., brown-outs, or requests for power reduction. The utilities 32 may generate the demand events 30 which are sent to a data gateway 34 of the data center. Alternatively, the demand events may be received directly by the inference engine 28 and send to each of the DR agents 26 or received directed by the DR agents. Further, the demand event may be generated in the control system 18 of the data center based on the available power from a back-up power system during a power outage by the utility or based on a need to reduce power consumption in the data center.

The DR inference engine 28 monitors the power consumption by the host severs 12 and analyzes which virtual machines and host servers may be idled or shut down to achieve a desired reduction in power consumption. The DR inference engine 28 may analyze the power consumption of the control center 10 to determine how to achieve a desired reduction, e.g., a ten percent (10%), in the power being consumed by the center. Based on its analysis, the DR inference determines which virtual machines and which host servers are to be idled or shut-down to achieve a desired power reduction. To determine which virtual machines and host servers to idle or shut-down, the DR inference engine may access information, e.g., data, related to the power consumption of the host servers, the virtual machines running on each of the host servers, and the requirements for availability of computer services by the virtual machines.

The DR inference engine 28 accesses a database engine 36 which may be hosted on a server in the control system 18. The database engine 36 accesses databases 38 in the control system, and obtains data needed or requested by the DR inference engine 28. The requested data may include information identifying the virtual machines subject to being controlled by a DR agent, the relationship between virtual machine and schedules indicating when certain virtual machines or computer services may be temporarily shut down or reduced.

The virtual machines subject to control by a DR agent may be determined based on a service agreement between a customer and the owner of the data center 10. The service agreement may offer the customer a discount or a rebate to agree that the computer service, e.g., website hosting, provided by the data center 10 may be suspended or reduced in the event of a demand event, such as a power failure, brown-out or increased cost of power. The service agreement may specify a service level agreement (SLA) that prescribes the extent to which the computer service provided by the data center may be suspended or reduced during a demand event. Further, the SLA may prescribe the demand event, such as a power outage by the utility. The control by a DR agent of a virtual machine may be subject to a schedule which prescribes periods, such as hours, e.g., 6 am to 7 pm Eastern Standard Time, or days, such as Monday to Friday each week, during which the computer service is not to be suspended by the DR agent.

In Step S6, a demand event 34 is sent by the utility to notify the data center of a power outage. In response to the power outage, the data center switches to a back-up power supply, which has a reduced capacity to provide power for an extended period as compared to the utility. The demand event prompts each DR agent 26 to determine whether to select virtual machines or host servers are to be idled or shut down, in step 7.

To determine whether to select the virtual machines to shut down or host servers, the DR agent associated with the virtual machine or host server requests the DR inference engine for information related to the virtual machines and host servers, in Step 8. The DR inference engine sends a request, in Step 9, for data from the data engine related to which virtual machines may be shut down or idled, which virtual machines are mirrored to other virtual machines, and which virtual machines are working together to, for example, support a website. The database engine 36 retrieves the requested data from the appropriate database(s) 38 and sends the requested data 40 to the DR inference engine.

Using the requested data and data analysis algorithms, the DR inference engine determines, in Step 10, how many virtual machines and host servers should be shut down to achieved a desired power reduction, e.g., a 10% power reduction, and to identify the virtual machines which may be idled or shut down, and identify console servers that may be shut down. Based on its determination, the DR inference engine 28 sends instructions or data to each of the DR agents 26 which is sufficient to enable the DR agents to identify the virtual machines to be idled or shut down.

In addition, the DR inference engine 28 may identify host servers that may be shut down or idled. These host servers may be supporting virtual machines that are mirrored on other host servers. Further, the DR inference engine may prompt the control system to perform a virtual machine setup and load balancing to shift virtual machines from host servers which have been designated to be idled or shut down.

The DR agents 26 on each of the host servers, upon receiving the instructions or data from the DR inference engine, selects which, if any, of the virtual machine on their respective host server may be idled or shut down in step 11. In step 12, the DR agents each issue instructions, e.g., commands, to cause the selected virtual machines to be idled or shut down.

In a similar manner as described above for a demand event reporting a power outage, a demand event indicating restoration of power may invoke a series of steps to cause the DR agents to restart those virtual machines that had been previously idled or shut down in Step 13.

Another approach is for the demand response events 30 to be received by and analyzed by the DR inference engine 30. In this approach, the approach the DR inference engine 30 could serve as the DR agent for each computer server. The DR inference engine 30 would issue instructions to selected virtual machines and host servers to idle or shut down, as well as to start-up.

The DR agents and DR inference engine manage the power consumption of the host servers during a demand event, such as a power failure, to achieve a desired change in the power consumption of the data center. The DR agents and DR inference engine provide a tool for data centers to implement agreements with its customers regarding a level of computer services when a demand event occurs, such as a power failure.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method to manage virtual machines operating on host servers in a data center comprising:
receiving demand event information at the data center;
a demand request (DR) inference engine responds to the demand event or a request by a demand request (DR) agent software module operating on one of the host severs, wherein the response by the DR inference engine is to identify virtual machines which may be shutdown or idled as a response to the demand event;
in response to the demand event information and information provided by the DR inference engine, the DR agent generates an instruction to a selected virtual machine on the host machine associated with the DR agent, and
in response to the instruction, the virtual machine shuts down or becomes idle.

2. The method of claim 1 wherein the demand event relates to a power outage and the information is supplied by a power utility.

3. The method of claim 1 further comprising the DR agent sending a subsequent instruction to the virtual machine in response to additional demand event information, wherein the virtual machine resumes operation in response to the subsequent instruction.

4. The method of claim 1 wherein the DR inference engine identifies virtual machines based on whether the virtual machines are designated as being available to being shut down or idled in response to a demand event.

5. The method of claim 1 further comprising determining a number of virtual machines to be shut down or idled to achieve a desired power reduction in the data center.

6. The method of claim 1 further comprising identifying a host server to be shut down or idled in response to the demand event information.

7. The method of claim 6 further comprising shifting functions of at least one of the virtual machines from the identified host sever to another host server before the identified host sever is shut down or idled.

8. A system to manage virtual machines operating on host servers in a data center, the system comprising:
the virtual machines are each hosted on a respective one of the host severs;
a demand agent on each of the host servers having a virtual machine, wherein the demand agent generates instructions to a selected at least one of the virtual machines on the host server having the demand agent and the instructions include commands to shut-down or idle and the instructions are generated using information regarding virtual machines which may be shut down or idled and a number of virtual machines to be shut down or idled, and
a demand request (DR) inference engine hosted on a host server in a control system of the data center, wherein the DR inference engine responds requests by the demand request (DR) agents for information regarding virtual machines which may be shutdown or idled in response to the demand event and a number of virtual machines to be shut down or idled.

9. The system in claim 8 further comprising a data gateway to the data center configured to receive demand event data indicating a demand event, wherein the demand event data prompts the demand agents or DR inference engine to shut down or idle the selected virtual machines to be shut down or idled.

10. The system in claim 9 wherein the demand event data relates to a power outage and the demand event data is transmitted to the data gateway from a source external to the data center.

11. The system of claim 8 wherein each of the DR agents sends a subsequent instruction to each of the selected virtual machines in response to additional demand event information, wherein the virtual machines resume operation in response to the subsequent instruction.

12. The system of claim 8 wherein the DR inference engine identifies virtual machines based on whether the virtual machines are designated as being available to being shut down or idled in response to a demand event.

13. The system of claim 8 wherein the DR inference engine determines the number of virtual machines to be shut down or idled to achieve a desired power reduction by the DR inference engine, and the DR agents select the number of virtual machines to be shut down or idled.

14. The system of claim 8 wherein the DR inference engine further identifies a host server to be shut down or idled in response to the demand event information.

15. The system of claim 14 wherein the DR inference engine shifts functions of at least one of the virtual machines from the identified host sever to another host server before the identified host sever is shut down or idled.
